(19) United States
(12) Patent Application Publication
(10) Pub. No.: US 2012/0318882 A1
(43) Pub. Date: Dec. 20, 2012

(54) VAPOR DELIVERY DEVICES

(75) Inventor: Benyamin Abehasera, Hollywood, FL (US)

(73) Assignee: Vapor Corp.

(21) Appl. No.: 13/526,450

(22) Filed: Jun. 18, 2012

Related U.S. Application Data
(60) Provisional application No. 61/520,892, filed on Jun. 16, 2011.

(51) Int. Cl. B05B 17/00; A24F 25/00

(52) U.S. Cl. 239/1; 131/329

(57) ABSTRACT

A vapor delivery device comprises a housing having a fluid inlet in fluid communication with a fluid outlet along a fluid flow path, and an energy storage unit, an atomizer, and a sensor within the housing. The energy storage unit is disposed in a chamber that fluidically isolates the energy storage unit from the fluid flow path.

### CROSS-REFERENCE

This application claims priority to U.S. Provisional Patent Application Ser. No. 61/520,892, filed Jun. 16, 2011, which application is entirely incorporated herein by reference.

### BACKGROUND

A cigarette in some cases is a small roll of finely cut tobacco leaves wrapped in a cylinder of thin paper. A cigarette may be ignited at one end and allowed to smoulder. Smoke from a cigarette may be inhaled from an opposing end of the cigarette.

Cigarette smoking may pose serious health issues. According to some estimates, about 4.9 million people die of cigarette-smoking related diseases each year, and others may experience non-fatal health related issues, such as respiratory diseases and cancer.

The active ingredient in some cigarettes is nicotine. During smoking, nicotine, along with a considerable amount of tar and aerosol droplets produced upon cigarette burning, enters a smoker's alveolus. In the alveolus nicotine may be absorbed into the blood of the smoker. There are alternative to cigarettes that aim to simulate the effects of cigarette smoking while minimizing the harmful consequences. Some cigarette substitutes containing only nicotine without tar have been proposed, such as nicotine patches. Although such cigarette substitutes may be free from tar, they may be incapable of delivering an effective peak concentration of nicotine to a user, in some cases due to slow absorption of nicotine.

Smoking devices, such as cigarette holders and pipes, may provide flavored vapor from a vaporizable substance to a user for therapeutic and smoking pleasure. However, some existing devices have little to no control of heating and combustion of tobacco products. Some devices may produce toxic, tarry and carcinogenic by-products that are harmful to a user, and may be associated with undesirable consequences during use, such as imparting a bitter and burnt taste to a mouth of the user.

### SUMMARY OF THE INVENTION

Recognized herein is the need for devices that are adapted to deliver a chemical, such as nicotine, to a subject (e.g., human), while minimizing the harmful effects of delivery, such as the harmful effects associated with cigarette smoking.

The disclosure provides systems and methods for vapor delivery. Such vapor delivery devices may be used as electronic cigarettes or flavor delivery devices (e.g., for delivering flavored tobacco). Such systems can be used for delivery of one or more chemicals to a subject, such as a drug (e.g., nicotine), or delivering other chemicals that may impart a given flavor to the subject.

In an aspect of the invention, a vapor delivery device comprises a housing having a fluid flow path comprising a fluid inlet, a fluid sensor, an atomizer, and a fluid outlet downstream of the fluid inlet. The housing is configured to facilitate the flow of a fluid from the fluid inlet to the fluid outlet upon the application of (i) a positive pressure source to the fluid inlet, or (ii) a negative pressure source to the fluid outlet. The vapor delivery device further comprises an energy storage unit disposed in a chamber of the housing and electrically coupled to the sensor. The chamber fluidically isolates the energy storage unit from the fluid flow path. The sensor is configured to electrically couple the energy storage unit to the atomizer upon fluid flow along the fluid flow path, which coupling provides power to the atomizer to vaporize a vaporizable substance in thermal communication with the atomizer. The vaporizable substance is then directed along the fluid flow path to the outlet.

Another aspect of the invention provides a vapor delivery device comprising a housing having a fluid inlet in fluid communication with a fluid outlet along a fluid flow path. The vapor delivery device further comprises an energy storage unit, an atomizer, and a sensor within the housing. The energy storage unit is disposed in a chamber that fluidically isolates the energy storage unit from the fluid flow path.

Another aspect of the invention provides a vapor delivery device, comprising a housing having a fluid flow path comprising a fluid inlet, a fluid sensor, an atomizer, and a fluid outlet downstream of the fluid inlet. The housing is configured to facilitate the flow of a fluid from the fluid inlet to the fluid outlet upon the application of (i) a positive pressure source to the fluid inlet, or (ii) a negative pressure source to the fluid outlet. The vapor delivery device further comprises an energy storage unit disposed in a chamber of the housing and electrically coupled to the sensor. The fluid flow path may be directed around the chamber along one or more channels (e.g., annular channels) formed between the chamber and an interior portion of the housing. The sensor is configured to electrically couple the energy storage unit to the atomizer upon fluid flow along the fluid flow path, which coupling provides power to the atomizer to vaporize a vaporizable substance in thermal communication with the atomizer. The vaporizable substance is then directed along the fluid flow path to the outlet.

Another aspect of the invention provides a method for vaporizing a vaporizable substance. The method comprises directing fluid flow along a fluid flow path of a housing, the fluid flow path comprising a fluid inlet, a sensor, an atomizer, and a fluid outlet. The housing comprises an energy storage unit in a chamber of the housing. The chamber fluidically isolates the energy storage unit from the fluid flow path. Next, fluid flow is sensed (or detected) by the sensor. Upon sensing fluid flow, the sensor electrically couples the energy storage unit to the atomizer to vaporize the vaporizable substance in thermal communication with the atomizer. Next, the vaporizable substance is directed along the fluid flow path to the fluid outlet.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” or “FIGS.” herein) of which:

FIG. 1 schematically illustrates a vapor delivery device, in accordance with an embodiment of the invention;

FIG. 2 schematically illustrates an alternative configuration of the vapor delivery device of FIG. 1, in accordance with an embodiment of the invention;

FIG. 3 schematically illustrates another alternative configuration of the vapor delivery device of FIG. 1, in accordance with an embodiment of the invention;

FIG. 4 schematically illustrates a single-piece vapor delivery device, in accordance with an embodiment of the invention;

FIG. 5 schematically illustrates a vapor delivery device with a divider to permit fluid (e.g., air) flow, in accordance with an embodiment of the invention;

FIG. 6 schematically illustrates a vapor delivery device with a T-shaped divider and a partially open chamber, in accordance with an embodiment of the invention;

FIG. 7 schematically illustrates the divider of FIG. 6, in accordance with an embodiment of the invention;

FIG. 8 schematically illustrates an alternative configuration of the vapor delivery device of FIG. 5, in accordance with an embodiment of the invention;

FIG. 9 is a perspective view of a sensor, in accordance with an embodiment of the invention;

FIG. 10 is an exploded side-view of the sensor of FIG. 9, in accordance with an embodiment of the invention;

FIG. 11 schematically illustrates a circuit diagram, as may be used with vapor delivery devices of the disclosure, in accordance with an embodiment of the invention;

FIG. 12 schematically illustrates another circuit diagram, as may be used with vapor delivery devices of the disclosure, in accordance with an embodiment of the invention; and

FIG. 13 schematically illustrates an electrical coupling configuration of various components of a vapor delivery device, in accordance with an embodiment of the invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed in practicing the invention.

The term “fluid,” as used herein, generally refers to a substance capable of flowing through a fluid flow path. A fluid may include a gas or a collection of gases. A fluid may be a substance that continually deforms (flows) under an applied shear stress, as may be provided by way of a pressure drop. In some examples, a fluid includes air, which may include nitrogen (N₂) and oxygen (O₂). A fluid may include solid, semi-solid or liquid particles entrained in a gas. In some cases, a fluid includes an aerosol. The aerosol may include solid particles entrained in a flowing air stream.

The invention provides vapor delivery devices that may aid in delivery of one or more chemicals, such as drugs or flavor-inducing (or flavor-imparting) chemicals, to a subject (e.g., human). Vapor delivery devices of the invention, when used as nicotine delivery devices, may help a subject maintain a given level of nicotine in the body of the subject, while minimizing, if not eliminating, at least some of the harmful consequences of cigarette smoking.

In some embodiments, an energy storage unit (e.g., lithium ion battery) of a vapor delivery device is housed or otherwise stored in a chamber. Such an arrangement minimizes, if not eliminates, fluid from a fluid flow path from coming in contact with the energy storage unit. During use, the energy storage unit may generate heat, which heat may vaporize one or more chemicals of the energy storage unit (e.g., electrolyte, solvent). By placing the energy storage unit in a chamber that may seal (e.g., hermetically seal) or otherwise fluidically isolate the energy storage unit from the fluid flow path, the likelihood of an appreciable quantity of such potentially hazardous chemicals from entering the fluid flow path and, in some cases, the body of a subject is reduced, if not eliminated.

### Vapor Delivery Devices

An aspect of the invention provides a vapor delivery device. The vapor delivery device in some cases is an electronic cigarette, which may be configured to deliver nicotine or other chemical (e.g., flavor inducing chemical) to a subject. The vapor delivery device comprises a housing having a fluid flow path comprising a fluid inlet, a fluid flow sensor, an atomizer (or vaporizer), and a fluid outlet downstream of the fluid inlet. The housing may be configured to facilitate the flow of a fluid from the fluid inlet to the fluid outlet upon the application of (i) a positive pressure source to the fluid inlet, or (ii) a negative pressure source to the fluid outlet. The vapor delivery device further includes an energy storage unit disposed in a chamber of the housing and electrically coupled to the sensor. The chamber fluidically isolates the energy storage unit from the fluid flow path. In some examples, the chamber is situated with respect to the fluid inlet such that fluid does not flow from the fluid inlet into the chamber, but may, for example, flow around the chamber towards the fluid outlet. The sensor is configured to electrically couple the energy storage unit to the atomizer upon fluid flow along the fluid flow path, which coupling provides power to the atomizer to vaporize a vaporizable substance in thermal communication with the atomizer. In such a case, the vaporizable substance can be directed along the fluid flow path to the outlet.

In an example, the chamber fluidically isolates the energy storage unit from the fluid flow path by not permitting fluid flow into the chamber, which may be open. One or more channels leading from the fluid inlet may be circumferentially aligned with one or more channels formed between the chamber and an internal portion of the housing such that, upon fluid flow along the fluid flow path, fluid flows from the fluid inlet to the one or more channels around the chamber and not into the chamber. In another example, the chamber fluidically isolates the energy storage unit from the fluid flow path by being fully sealed. In such a case, the fluid flow path may come in contact with various portions of the chamber, but fluid may not enter the chamber.

The chamber fluidically isolates the energy storage unit from the fluid flow path. In such a case, little to no fluid atoms and/or molecules from the fluid flow path come in contact with the energy storage unit (e.g., battery) upon fluid flow from the inlet to the outlet. In some cases, the fluid flow path comes in contact with the chamber, but the chamber minimizes, if not prevents, the fluid in the fluid flow path from coming in contact with the energy storage unit. This may advantageously prevent potentially hazardous chemicals from being entrained in the fluid and directed to a subject, which may be inhaled and lead to unwanted or undesirable health consequences.

The energy storage unit can be a battery, such a nickel cadmium battery or a lithium ion battery. The battery may be a disposable battery. In some cases, the battery may be a rechargeable battery. The energy storage unit may include a photovoltaic module configured to generate electricity upon exposure to electromagnetic radiation.

In an example, the energy storage unit is a lithium ion battery. In some cases, upon operation of the lithium ion battery, one or more gases that may be harmful to a subject are released. The vapor pressure of such one or more gases may be increased upon an increase in temperature of the lithium ion battery.

An external energy source may be used as an alternative to, or in conjunction with, the energy storage unit. In an example, the energy storage unit is coupled to an external energy source, such as a power source, through an electrical coupling member, such as, e.g., a power cord. In some cases, the energy storage unit is coupled to the power supply of a computer through a port of the computer, such as a universal serial bus (USB) port of the computer. In some examples, the energy storage unit is precluded, and the device is coupled to an external source of energy through an electrical coupling member. As an alternative, the energy storage unit may include an electrical coil that is configured to inductively couple to an external source of a magnetic field, which coupling may induce the flow of electricity in the coil. The flow of electricity can be used to provide power to the atomizer. In some cases, electricity produced by the application of the magnetic field to the coil can be stored in the energy storage unit (e.g., in a battery of the energy storage unit in electrical communication with the coil) for later use.

In some cases, the chamber hermetically seals the energy storage unit in the housing. The chamber may seal the energy storage unit from the external environment. The chamber may be under vacuum or an inert environment. The chamber may provide an airtight seal, in which case the chamber may be impervious to air or gas.

The chamber may be a single piece unit or a multi-piece unit. In some cases, the chamber is cylindrical in shape and has one or more compartments for housing the energy storage unit. A side of the chamber may be sealed by with the aid of a metallic material and a polymeric material (e.g., polyepoxide, or “epoxy”). In some situations, the chamber is formed from one or more interior walls of the housing. For instance, the housing may be cylindrical in shape and the energy storage unit may be inserted from an opening of the housing. A cap may be provided adjacent to the energy storage unit and one or more openings between the cap and the interior wall of the housing can be sealed with the aid of a polymeric material to form a seal between the cap and the interior wall of the housing. Any opposing opening may be sealed in a similar fashion, thereby hermetically sealing the energy storage unit in the chamber. In some situations, however, the chamber may not be hermetically sealed from the external environment, but a side of the chamber adjacent or in proximity to the fluid flow path may be isolated from the fluid flow path, such as with the aid of a polymeric material, to minimize, if not prevent, the fluid flow path from coming in contact with the energy storage unit.

The housing may have various shapes and sizes, and configurations. The housing can be cylindrical or rectangular. The housing in some cases is shaped like a cigarette. The housing can be single-piece or multi-piece unit. For instance, the housing can be a two-piece or three-piece unit. A three-piece housing can include a separate compartment for holding a vaporizable substance (e.g., nicotine), which may be removed from the housing to refill the vaporizable substance.

In some cases, the housing comprises a first housing module removably attached to a second housing module. The first housing module comprises the chamber. In some cases, the sensor is situated in the first housing module. Alternatively, the sensor can be situated in the second housing module. The atomizer may be situated in the second housing module.

The sensor can be a single-piece unit or a multi-piece unit. In some cases, the sensor is formed on a printed circuit board (PCB) that includes electrical components, such as an operational amplifier, microcontroller (MCU), metal-oxide-semiconductor field-effect transistor (mosfet) and/or comparator. The sensor can include a capacitive unit or part (also “capacitive sensor” herein). The housing may comprise an electronic visual indicator electrically coupled (e.g., through a wired connection) to the sensor. In such a case, the sensor is configured to electrically couple the energy storage unit to the electronic visual indicator upon fluid flow along the fluid flow path. The electronic visual indicator can be a light emitting diode (LED) or a plurality of LED's. In some cases, the electronic visual indicator is adapted to emit light that may give the appearance of a burning flame. In an example, the electronic visual indicator emits red or orange-to-red light. The sensor may be a pressure sensor, which may use one or more diaphragms and a pressure cavity to create a variable capacitor to detect strain due to applied pressure, as may vary upon fluid flow. In some examples, the pressure sensor is coupled to a MCU, and upon the flow of a fluid (e.g., air) the pressure sensor triggers the MCU, which subsequently provides an electrical flow path leading from the energy storage unit to the atomizer.

In some situations, the sensor comprises an electronic controller and a fluid flow-triggered switch. The fluid flow-triggered switch may be an air-triggered switch. The fluid flow-triggered switch can be electrically coupled to the electronic controller. In an example, the fluid flow-triggered switch and the electronic controller are formed on a PCB. In another example, the fluid flow-triggered switch and electronic controller are separate pieces, and may be separate situated in the housing. In some cases, the fluid flow-triggered switch is configured to electrically couple the energy storage unit to the atomizer upon fluid flow through or in proximity to the fluid flow-triggered switch.

In an example, the sensor comprises a fluid flow-triggered switch and an electronic controller. The fluid flow-triggered switch is situated along the fluid flow path. The electronic controller may be situated in the fluid flow path, though in some cases the electronic controller is not situated in the fluid flow path. In an example, the housing comprises, in sequence, the fluid inlet, fluid air-triggered switch, atomizer and fluid outlet.

The decoupling of the fluid flow-triggered switch and the electronic controller can permit the fluid flow-triggered switch to be situated at a location which may permit flexibility in the design of the device. For instance, the fluid inlet can be situated at a location of the housing such that fluid flow through or around the chamber is minimized. The fluid flow-triggered switch can be situated between the fluid inlet and the fluid outlet, in some cases adjacent to the atomizer. This may permit fluid flow to trigger the fluid flow-triggered switch, which may direct the electronic controller to supply power from the energy storage unit to the atomizer to generate vapor (e.g., gas molecules, aerosol).

There are a variety of configurations for the sequential placement of the fluid inlet, fluid outlet, chamber, atomizer, and sensor. Such configurations may be described in relation to a longitudinal axis of the housing, which axis is oriented along a length of the housing.

In an example, along a longitudinal axis of the housing, the fluid inlet is disposed between the energy storage unit and the fluid outlet. As an alternative, along the longitudinal axis of the housing, the sensor is disposed between the chamber and the atomizer.

In another example, the housing comprises, in sequence, the chamber, fluid inlet, fluid sensor, atomizer and fluid outlet. Alternatively, the housing comprises, in sequence, the chamber, fluid inlet, atomizer, fluid sensor and fluid outlet. As yet another alternative, the housing comprises, in sequence, the fluid inlet, fluid sensor, chamber, atomizer and fluid outlet.

The housing may further include a holding unit adapted to store a vaporizable substance, such as a solid, gel or liquid. The holding unit in some cases is a storage vessel, such as a container. The holding unit may be in thermal communication with the atomizer. In some cases, the holding unit is in thermal contact with the atomizer.

The atomizer can include a resistive heating element that is in proximity to the holding unit. In some examples, the atomizer includes one or more filaments. A filament can be formed of a metal or metal alloy, such as, for example, tungsten. The atomizer may include a wicking mesh (e.g., metal mesh) to draw in a vaporizable substance from the holding unit. Alternatively, the atomizer can include a piezoelectric element that is configured to vaporize the vaporizable substance.

The atomizer and holding unit may be separate components. As an alternative, the atomizer and holding unit may be provided in an integrated unit, such as a cartomizer.

The holding unit can be a container having a liquid. Alternatively, the holding unit is a sponge or other absorbent that is adapted to retain one or more chemicals, such as nicotine or a flavor inducing substance, and in some cases an oil and/or an herb. The holding unit in some cases may include a solution, which can be a pure liquid. As an alternative, the holding unit can include an absorbent (e.g., cotton) having a vaporizable substance. The absorbent may be produced by dipping the absorbent in a liquid having the vaporizable substance.

In some embodiments, a vapor delivery device comprises a housing having a fluid inlet in fluid communication with a fluid outlet along a fluid flow path. The device further comprises an energy storage unit, an atomizer, and a sensor within the housing. The energy storage unit is sealed in a chamber that fluidically isolates the energy storage unit from the fluid flow path.

Reference will now be made to the figures, wherein like numerals refer to like parts throughout. It will be appreciated that the figures and components therein are not necessarily drawn to scale.

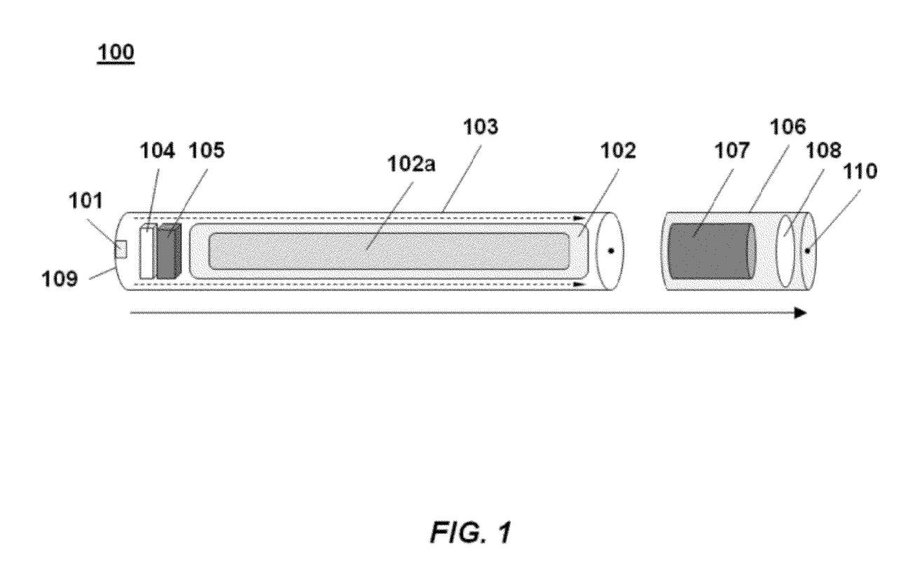

FIG. 1 schematically illustrates a vapor delivery device 100, in accordance with an embodiment of the invention. The vapor delivery device 100 may be an electronic cigarette, which is configured to deliver nicotine, nicotine derivative, or nicotine substitute to a subject. The vapor delivery device 100 includes a visual indicator 101, chamber 102, tube 103, electronic controller 104, fluid flow-triggered switch 105, cartridge 106, atomizer 107, a holding unit 108 having a vaporizable substance, fluid inlet 109 and fluid outlet 110. The atomizer 107 may be as described elsewhere herein. In an example, the atomizer 107 is a filament. The fluid inlet 109 and the fluid outlet 110 may each include a hole and/or a slit, or multiple holes and/or slits. The chamber 102 includes an energy storage unit 102a, such as a battery. The right pointing arrow from fluid inlet 109 to the fluid outlet 110 depicts the direction of fluid (e.g., air) flow upon the application of a pressure drop from the fluid inlet 109 to the fluid outlet 110. The dashed lines between the chamber 102 and an interior portion of the tube 103 indicate the direction of fluid flow through one or more channels formed between the chamber 102 and the interior portion of the tube 103. The fluid outlet 110 is adapted to rest adjacent to, or within, the mouth of a subject during use. A housing of the vapor delivery device 100 includes the tube 103 and the cartridge 106.

The tube 103 may be separable from the cartridge 106 (or vice versa), though in some cases the tube 103 and cartridge may be single-piece (or unitary). If the tube 103 is separable from the cartridge 106, during use of the device 100, the tube 103 can be joined (or mated to) the cartridge 106.

The tube 103 may be formed of a polymeric material (e.g., plastic), metallic material (e.g., aluminum), or a composite material. The cartridge 106 may be formed of a polymeric material. The cartridge 106 may be disposable. In some cases, the cartridge 106 is formed of a spongy or deformable material (e.g., a deformable polymeric material), which is configured to deform upon the application of pressure and, in some cases, return to its original shape absent applied pressure.

During use, fluid is directed from the fluid inlet 109 around the chamber 102 to the fluid outlet 110. Fluid flow is induced upon the application of negative pressure (e.g., vacuum) to the fluid outlet 110 and/or positive pressure to the fluid inlet 109. The pressure drop directed from the fluid inlet 109 to the fluid outlet 110 is induced by a pressure differential between the fluid inlet 109 and the fluid outlet, leading to fluid flow along a fluid flow path leading from the fluid inlet 109 to the fluid outlet 110.

Various configurations of the components of a vapor delivery device may be employed. For instance, the electronic controller (“controller”) 104 and/or the fluid flow-triggered switch (“switch”) 105 may be located in the tube 103 or the cartridge 106.

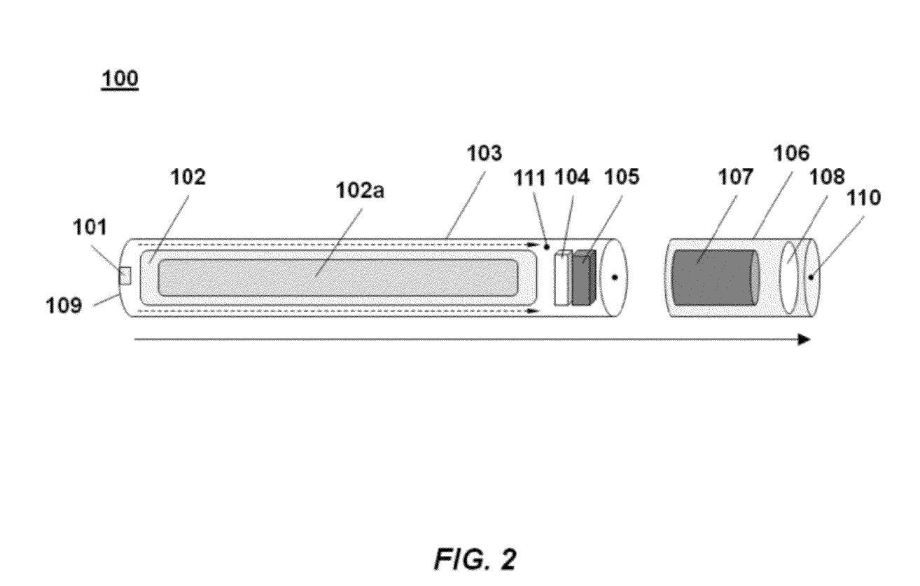

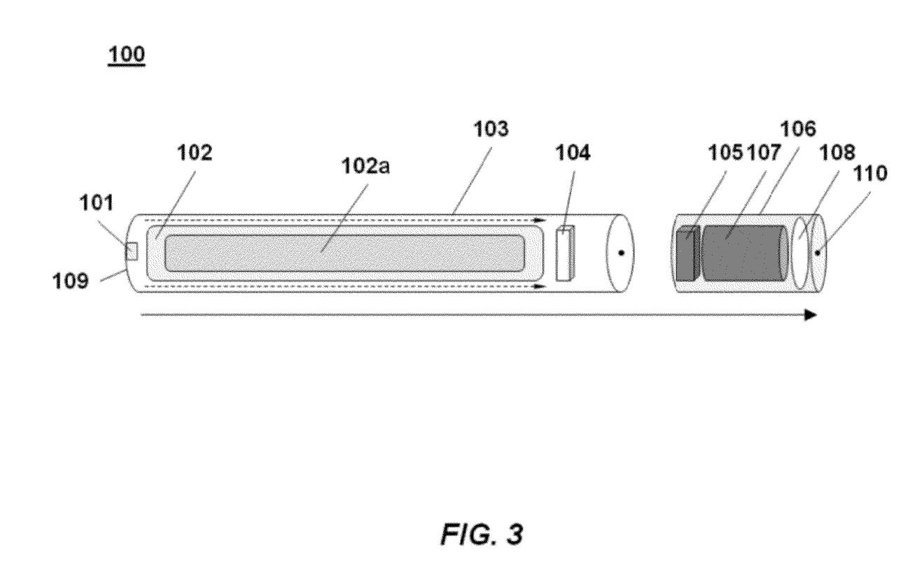

FIG. 2 schematically illustrates an alternative arrangement of the electronic controller 104 and the fluid flow-triggered switch 105. In the illustrated example, the controller 104 is disposed adjacent to the chamber 102, and the switch 105 is disposed adjacent to the controller 104. The controller 104 and switch 105 are situated in the tube 103. FIG. 3 shows an alternative arrangement in which the switch 105 is situated in the cartridge 106 and the controller 104 is disposed in the tube 103. As another alternative (not shown), the controller 104 and the switch 105 can be disposed in the cartridge 106.

The tube 103 may include a side fluid inlet 111, which may include a hole and/or a slit, or multiple holes and/or slits. The slide fluid inlet 111 is situated on or along a side of the housing of the device 100. In an example, the side fluid inlet 111 is a hole, such as a circular, triangular, square or rectangular hole. The side fluid inlet 111 is in fluid communication with the fluid outlet 110. In some cases, the fluid inlet 109 may be excluded and, during use of the device 100, a fluid (e.g., air) may be directed from the side fluid inlet 111 to the fluid outlet 110.

In some cases, the cartridge 106 can include an attachment member, such as a metallic screw-type attachment member, that can electrically couple various electrical components in the tube 103 and the cartridge 106 to one another. The cartridge 106 can include a male attachment member that is mountable to a female attachment member of the tube 103. Alternatively, the cartridge 106 can include a female attachment member that is mountable to a male attachment member of the tube 103. The attachment members can permit electronic components in the tube 103 and the cartridge 106 to be electrically coupled to one another. For instance, the switch 105 and the controller 104 of FIG. 3 can be electrically connected to one another through a metallic screw-type attachment member. In an example, the cartridge 106 has a male screw-type attachment member that can be fastened (e.g., by turning the cartridge 106 clockwise in relation to the tube 103) into a female screw-type attachment member (e.g., receptacle) of the tube 103. In some examples, during use, fluid flows from the side fluid inlet 111 through the switch 105 to the outlet 110.

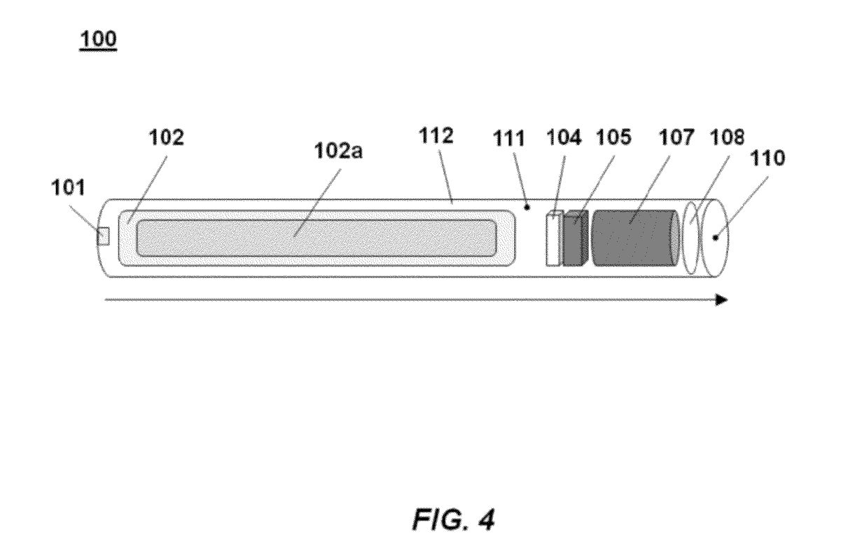

The housing can be a multi-piece component. In the illustrated examples of FIGS. 1-3, the housing is a two-piece component comprising the tube 103 and the cartridge 106, which are separable. With reference to FIG. 4, as an alternative, the vapor delivery device 100 comprises a housing 112 that is a single-piece component. The housing 112 includes the side fluid inlet 111 situated between the chamber 102 and the controller 104. The side fluid inlet 111 can include a hole and/or a slit, or multiple holes and/or slits. In an example, the side fluid inlet 111 is a hole, such as a circular, triangular, square or rectangular hole. The side fluid inlet 111 is in fluid communication with the fluid outlet 110.

A housing of the device 100 can be formed of a metallic material, a polymeric material, or a composite material. In an example, the housing 112 of FIG. 4 is formed of a polymeric material. In another example the tube 103 is formed of a metallic or polymeric material, and the cartridge 106 is formed of a polymeric material. In some cases, at least some of the material of the housing may include recycled material. In some instances, the housing is recyclable.

In some cases, such as that illustrated in FIGS. 1-4, the controller 104 and the switch 105 are separate components. The switch 105 may be situated along a fluid flow path leading from the fluid inlet 109 and/or the side fluid inlet 111 to the fluid outlet 110.

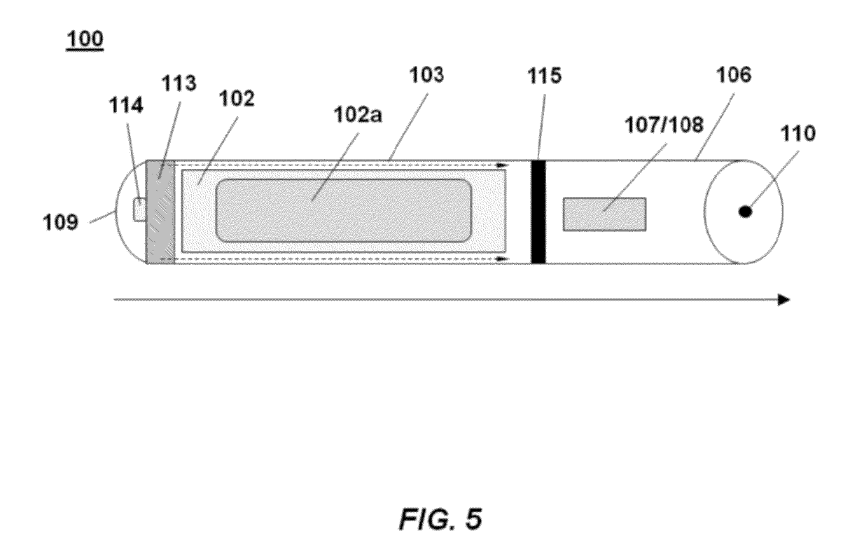

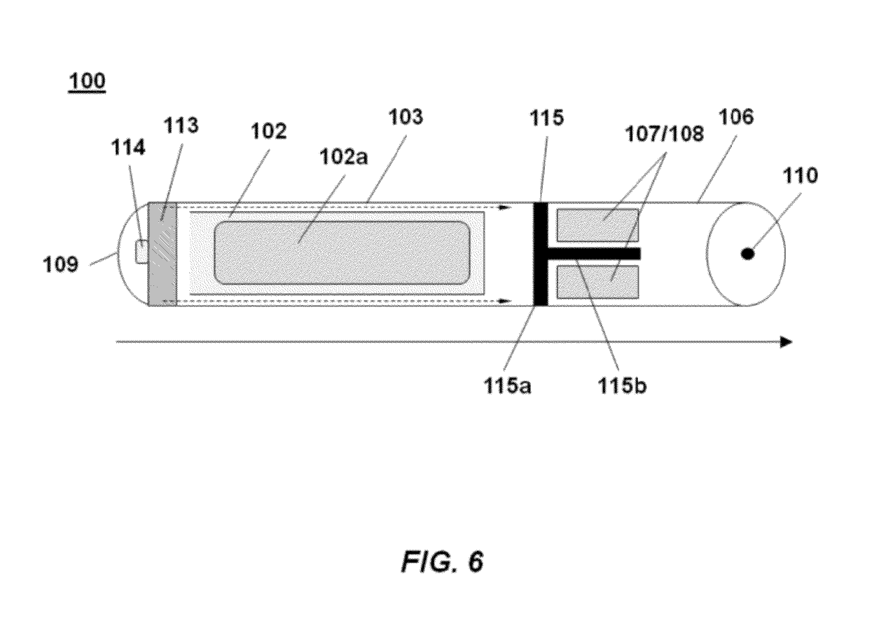

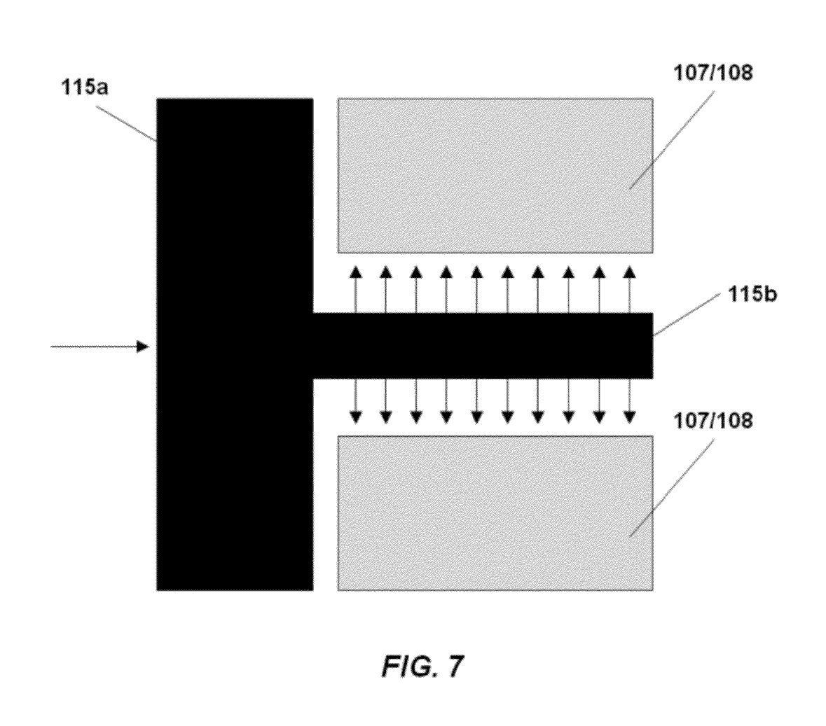

As an alternative, the controller 104 and the switch 105 may be part of an integrated, single component. For instance, the controller 104 and switch 105 can be formed on a printed circuit board (PCB). FIG. 5 shows the device 100 having a sensor 113 that includes an integrated fluid flow-triggered switch and controller (e.g., microcontroller). The fluid flow-triggered switch may be a capacitive unit that may be configured to turn the device 100 ON or OFF based on a change a capacitance of the capacitive unit. The controller may be formed on a PCB (not shown). The sensor 113 may include an integrated electronic visual indicator 114, such as an LED. The visual indicator 114 may be similar or identical to the visual indicator 101 above. In the illustrated example, the tube 103 and the cartridge 106 are removably mated together. A divider 115 between the tube 103 and the cartridge 106 is configured to permit fluid (e.g., air) flow through the device 100. The general direction of fluid flow is indicated by the arrow pointing from the fluid inlet 109 to the fluid outlet 110 (i.e., right-pointing arrow). In an example, the divider 115 is formed of a polymeric material, such as rubber. The divider 115 can include a through hole for permitting fluid flow into the device 100. With reference to FIG. 6, in an example, the divider 115 is “T” shaped (see below), having a top portion 115a and a stem portion 115b that extends generally orthogonally with respect to the top portion 115a. The stem portion 115b of the divider 115 may have a channel extending through at least a portion of the stem portion 115b, which channel can permit fluid flow, such as, e.g., from a location external to the device 100 to the atomizer 107, or from the tube 103 to the cartridge 106. The atomizer 107 and the holding unit 108 may be situated in proximity to the stem portion 115b. In some cases, the atomizer 107, the holding unit 108, or both are in contact with the stem portion 115b. As an alternative, the atomizer 107 or the holding unit 108 is not in contact with the stem portion 115b. As another alternative, the atomizer 107 and the holding unit 108 are not in contact with the stem portion 115b. The stem portion 115b may include one or more holes for permitting fluid from the channel of the divider 115 to exit the divider 115 and come in contact with the vaporizable substance. The one or more holes may be in fluid communication with one or more channels extending through the stem portion 115b and in fluid communication with one or more openings in the top portion 115a of the divider 115. With reference to FIG. 7, the stem portion may 115b include a plurality of holes for permitting fluid to exit the channel of the divider 115 and come in contact with the atomizer 107 and holding unit 108. The arrows indicate the direction of fluid flow into the divider 115 and out of the stem portion 115b of the divider 115.

The chamber 102 may be completely sealed or open at one or more ends of the chamber 102. In the illustrated examples of FIGS. 1-5, the chamber 102 is completely sealed. With reference to FIG. 6, the chamber 102 is open at an end adjacent to the sensor 113 (left end of the chamber 102). However, the chamber 102 can be positioned such that fluid flows into the device 100 from the fluid inlet 109 and flows around the chamber 102 without entering the opening of the chamber 102 and coming in contact with the battery 102a. Fluid can flow around the chamber 102 through one or more channels formed between the chamber 102 and one or more internal portions of the tube 103 (see FIG. 6, dashed arrows between the chamber 102 and the tube 103). The channel around the chamber 102 may be formed between the chamber and an internal wall of the tube 103 of the housing. Fluid then flows to the divider 115 and comes in contact with the atomizer 107 and holding unit 108. Such a configuration may fluidically isolate the battery from the fluid flow path extending from the fluid inlet 109 to the fluid outlet 110. In an example, the fluid flow path is directed from the fluid inlet 109 to an opening of the sensor 113. One or more fluid exit ports of the sensor 113, when viewed along a cross-section of the sensor 113, may be situated such that fluid from the sensor 113 is directed around the chamber 102 but not into the chamber 102. Fluid may flow around the chamber 102 and to the divider 115 without coming in contact with the battery 102a during use of the device 100.

Although the divider 115 of FIGS. 6 and 7 is “T” shaped, the divider 115 may have other shapes and configurations. For example, the stem portion 115b can extend to a position in proximity to the fluid outlet 110. In some situations, the holding unit 108 and/or vaporizable substance (e.g., liquid) is not in contact with the stem portion 115b, which aids in preventing liquid from entering the one or more channels in the stem portion 115b. As another example, the stem portion is curvilinear (e.g., serpentine) with respect to the top portion 115a. This may aid in increasing the length of one or more channels in the stem portion 115b while aiding in minimizing the width (along an axis from the top portion 115a towards the fluid outlet 110) of the stem portion 115b.

With reference to FIGS. 5 and 6, the sensor 113 is disposed in the tube 103 and adjacent to the fluid inlet 109. In such a case, upon the application of a pressure drop across the device 100, such as upon a subject imparting negative pressure (e.g., suction) to the fluid outlet 110, fluid (e.g., air) enters the fluid inlet 109 and passes through or in proximity to the sensor 113. Upon fluid flow, a fluid flow-triggered switch of the sensor 113 (e.g., the switch 105) directs the energy storage unit 102a to provide power to the atomizer 107, thereby vaporizing a vaporizable substance. The vaporizable substance enters the flowing fluid and is directed to the fluid outlet 110.

With continued reference to FIG. 5, the chamber 102 may seal (e.g., hermetically seal) the energy storage unit 102a and isolate the energy storage unit 102a from a fluid directed through the device 100. This aids in preventing, if not minimizing, potentially hazardous chemicals from entering the gas phase and being entrained in the flowing fluid from the fluid inlet 109 to the fluid outlet 110, as may be case if the temperature of the energy storage unit 102a increases during use.

The chamber 102 can be formed of a metallic material, polymeric material, or composite material. In some cases, the chamber 102 is formed of a metallic material, such as aluminum. As an alternative, the chamber 102 may be formed of a polymeric material. The polymeric material may have a glass transition temperature that is selected to be above a maximum temperature of the energy storage unit 102a during use.

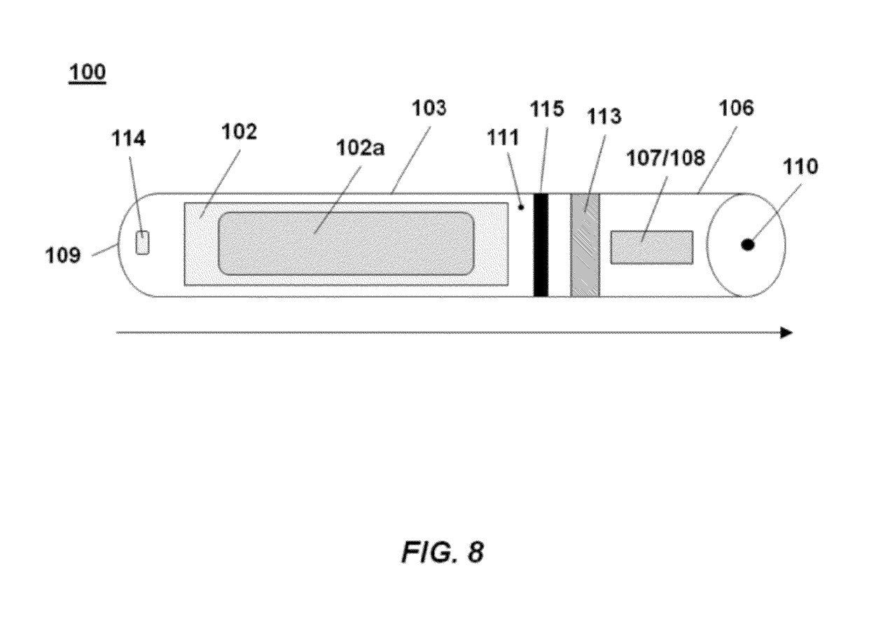

With reference to FIG. 8, as an alternative to the arrangement of components of FIG. 5, the sensor 113 may be disposed in the cartridge 106. The electronic visual indicator 114 may be a separate component in relation to the sensor 113 and disposed adjacent to the fluid inlet 109. The visual indicator 114 may be electrically coupled to the sensor 113 via an electrical coupling member, such as, for example, a wire. In such a case, the sensor 113 directs the energy storage unit 102a to provide power to the atomizer 107 and the visual indicator 114 upon fluid flow from the inlet 109 to the outlet 110. The divider 115 can provide a seal between the internal volumes of tube 103 and the cartridge 106. The divider 115 may be as described above in the context of FIGS. 5-7. In some cases, the fluid inlet 109 may be precluded, and fluid may enter the device 100 through the slide fluid inlet 111, which may be formed in a body of the tube 103 (as shown), a body of the cartridge 106 (not shown), or both. In other cases, the fluid inlet 109 and side fluid inlet 111 are both provided. As an alternative, the side fluid inlet 111 may be precluded, and fluid may enter the device 100 through the fluid inlet 109. As another alternative, the fluid inlet 109 and side fluid inlet 111 are precluded, and the divider 115 is adapted to enable fluid to enter the device 100 and subsequently come in contact with the sensor 113. In such a case, a fluid flow path is directed from the divider 115 (e.g., through a side opening of the divider 115 that is exposed to an environment external to the device 100) to the fluid outlet 110 and does not come in contact with the chamber 102.

The divider 115 may be situated along a fluid flow path of the device 100. The divider 115 can bisect the housing (and an interior of the housing) into a first portion and a second portion. In an example, the first portion is a volume within the tube 103 and the second portion is a volume within the cartridge 106. The first portion and second portion can be of equal volume, or different volumes. The first portion and second portion can be in fluid communication with one another through the divider 115, such as through a channel directed from the top portion 115a to the stem portion 115b of the divider 115.

The chamber 102 may be completely closed or, alternatively, partially open at one or more ends (see, e.g., FIG. 6). This may provide the benefits of fluidic isolation of the energy storage unit 102a while enabling savings in material costs, in addition to potentially simplifying electrical connectivity to the energy storage unit 102a. In an example, the sensor 113 is situated in the cartridge 106 and the chamber 102 is partially open at an end oriented away from the sensor 113. The fluid inlet 109 may be situated such that one or more channels around the chamber 102 are aligned with the fluid inlet 109, thereby preventing fluid from flowing into the chamber 102 and coming in contact with the energy storage unit 102a.

With reference to FIGS. 5-8, the atomizer 107 and holding unit 108 have each been shown as a single unit, as may be the case if the atomizer 107 and holding unit 108 are provided in a cartomizer. However, the atomizer 107 and holding unit 108 can be separate units, as described elsewhere herein. In some cases, the atomizer 107 and holding unit 108 are part of an integrated unit. Alternatively, the atomizer 107 and holding unit 108 may be separate units. In an example, the holding unit 108 is a cotton roll soaked in a vaporizable substance (e.g., nicotine, tobacco, flavor-inducing substance), and the cotton roll circumscribes at least a portion of the atomizer 107 (e.g., the cotton roll wraps around the atomizer 107).

The sensor 113 may have various configurations. The sensor 113 may be an embedded system, including a microcontroller (MCU) unit and software, as well as a fluid flow sensor which may function as an ON/OFF switch for the atomizer as well as the visual indicator 114, which may simulate a source of heat (e.g., fire).

In some cases, the energy storage unit 102a is a battery, such as a lithium ion battery. The energy storage unit may be a rechargeable battery. In an example, the energy storage unit 102a is a lithium ion battery rated at 3.7 volts to 4.2 volts (direct current), with variable power (current) capacity.

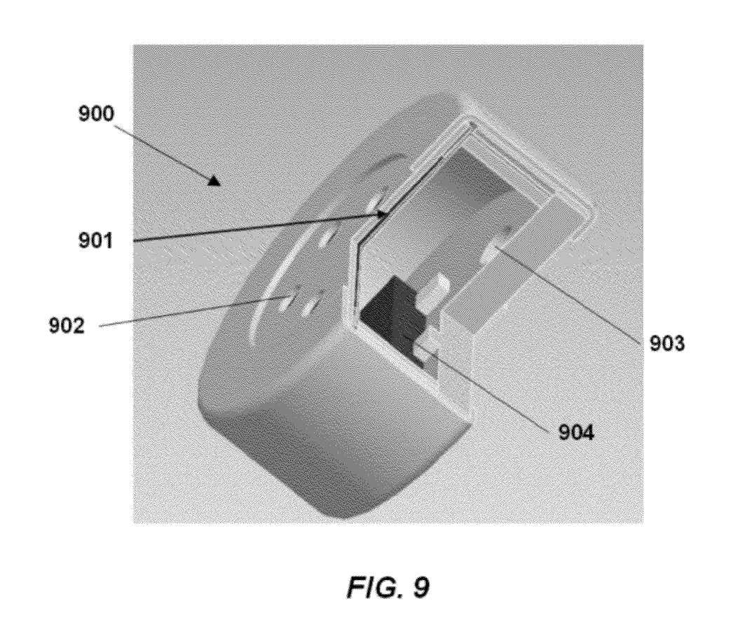

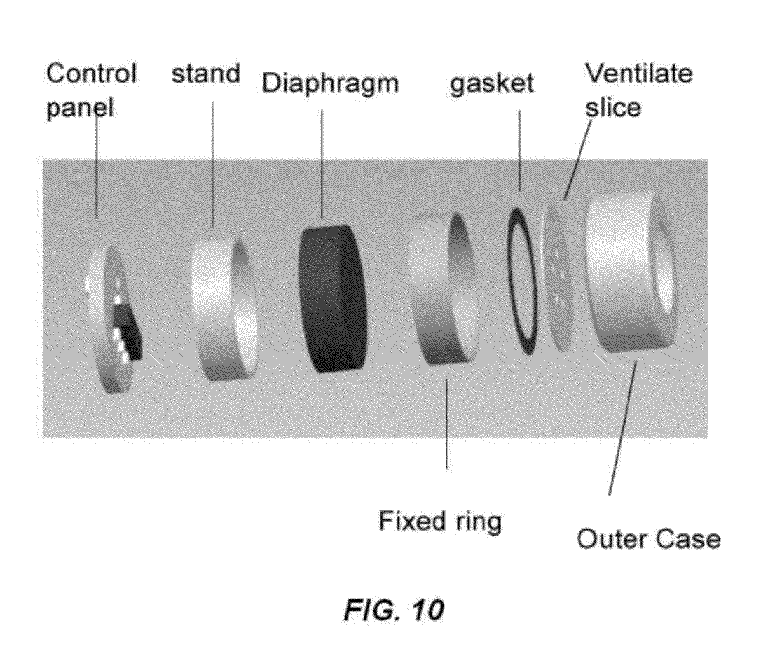

The sensor 113 may be a capacitive sensor. With reference to FIG. 9, in an example, a sensor 900 is shown having diaphragms 901 that are situated adjacent to a fluid inlet 902 of the sensor 900. FIG. 10 is an exploded side-view of the sensor 900. The sensor 900 may be the sensor 113 described elsewhere herein. The sensor 900 comprises a first diaphragm parallel to (and adjacent to) a second diaphragm (e.g., circular diaphragms). The first and second diaphragms have a capacitance that is a function of the distance between the diaphragms 901. Upon the application of a pressure drop from a fluid inlet 902 of the sensor 900 to a fluid outlet 903 of the sensor 900, the distance between the diaphragms 901 changes. The change in distance effects a change in capacitance of the sensor 900. Such a change in capacitance may be detected by a controller 904 (e.g., operational amplifier, microcontroller) of the sensor 900 (see, also, FIG. 10).

The sensor 900 may be electrically coupled to an energy storage unit and an atomizer (and in some cases a visual indicator). In some cases, absent a pressure drop across the diaphragms 901, there is no electrical flow path between the energy storage unit and the atomizer. Upon the application of a pressure drop, the controller 904 may detect a change in capacitance and provide an electrical flow path between the energy storage unit (e.g., the energy storage unit 102a) and the atomizer (e.g., the vaporizer 107) and, in some cases, a visual indicator (e.g., the visual indicator 101 or 114). Upon the removal of the pressure drop, such as upon the equalization of pressure across the diaphragms 901, the controller 904 removes the electrical flow path between the energy storage unit and the atomizer.

In some cases, the controller 904 detects a threshold change in capacitance, such as a change in capacitance that is at or above a given value. A change in capacitance at or above the threshold may be indicative of fluid flow, and a change in capacitance below the threshold may be indicative of no fluid flow. Such determination may be made by the controller 904 with the aid of onboard software.

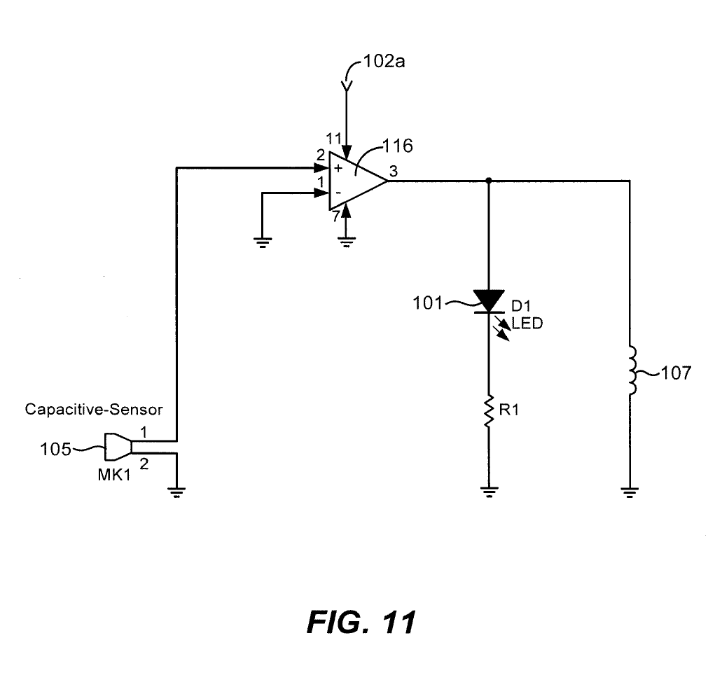

FIG. 11 is an exemplary circuit diagram showing certain electronics components of the device 100, in accordance with an embodiment of the invention. The energy storage unit 102a is coupled to an operational amplifier 116, as may be provided in the controller of the device (e.g., controller 104). The fluid flow-triggered switch 105 may be integrated with the controller 104. In some examples, the electronic controller 104 and the fluid flow-triggered switch 105 are provided in an integrated sensor, such as, for example, the sensor 113.

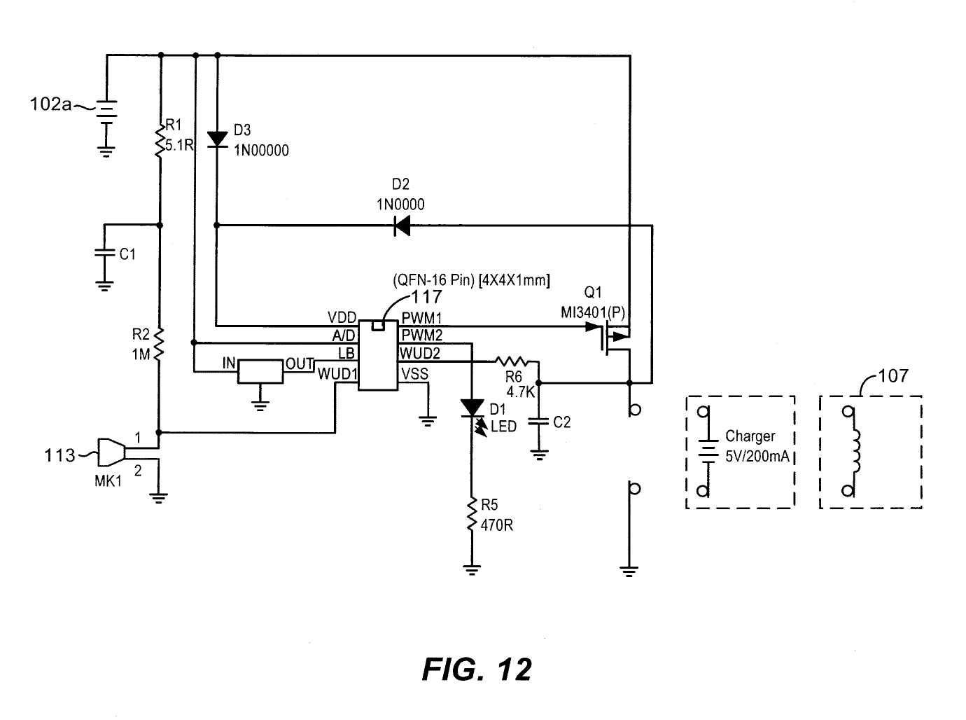

FIG. 12 shows another exemplary circuit diagram, as may be used with the device 100. The circuit of FIG. 12 includes a controller 117, which may be a microcontroller. The controller 117 is coupled to the sensor 113 and the energy storage unit 102a. The circuit diagram of FIG. 12 may not include an operational amplifier.

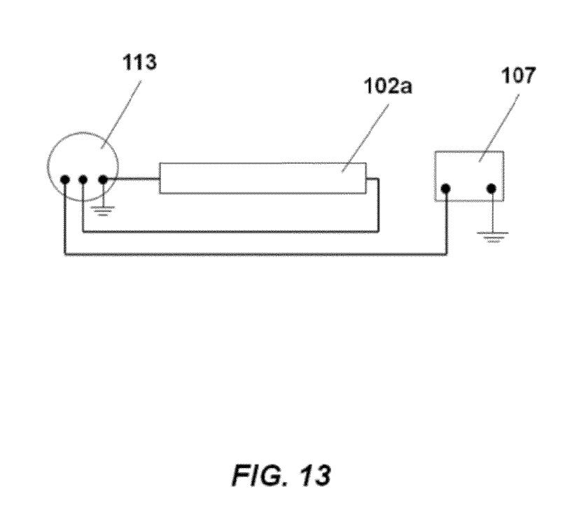

FIG. 13 schematically illustrates an exemplary electrical coupling diagram of the device 100, showing an electrical coupling between the energy storage unit 102a, the atomizer 107 and the sensor 113. The sensor 113 may include a PCB having an integrated controller and a fluid flow-triggered switch (e.g., air flow-triggered switch). Upon the flow of fluid through the sensor 113, the sensor 113 directs the energy storage unit 102a to provide power to the atomizer and, if present, a visual indicator (e.g., the visual indicator 101 or 114).

The energy storage unit 102a, atomizer 107 and sensor 113 may be electrically coupled to one another through electrically conductive components, such as wires (e.g., copper wires). The electrically conductive components can include a portion of the housing of the device that is adapted to conduct electricity, as may be provided in a male and/or female attachment member of the device (see above).

In some embodiments, the chamber 102 may be completely closed (or sealed). In the illustrated examples of FIGS. 1-5 and 8, the chamber 102 is sealed from an internal portion of the device. As an alternative (see, e.g., FIG. 6), the chamber 102 may be unsealed, but the chamber 102 may be situated such that the battery 102a is fluidically isolated from the fluid flow path, in some cases with the aid of the divider 115. Such fluid isolation may aid in minimizing, if not preventing, one or more chemicals from the energy storage unit (e.g., battery) 102a to enter the fluid flow path and subsequently come in contact with a subject during use of the device 100 by the subject.

The device 100 and the components of the device 100 may have various sizes and configurations. The housing of the device 100 may be cylindrical and have a diameter (as measured from a centerline of the device 100 to an external surface of the housing) between about 8 millimeters (mm) and 10 mm, or 8.5 mm and 9.5 mm, and a length (as measured from the fluid outlet 110 to an end of the device 100 opposite from the fluid outlet 110, such as the fluid inlet 109) between about 60 mm and 120 mm, or 80 mm and 115 mm. In an example, the device 100 has a diameter of about 9.4 mm and a length of about 115 mm. The housing (e.g., plastic or aluminum housing) may have a thickness between about 0.05 mm to 0.4 mm, or about 0.15 mm and 0.25 mm. In an example, the housing has a thickness of about 0.2 mm. The energy storage unit 102a may have a diameter between about 6 mm and 10 mm, or 8.5 mm and 9.5 mm. In an example, the energy storage unit 102a is a battery (e.g., lithium ion battery) with a diameter of about 8 mm. The chamber 102 may have a diameter between about 7 mm and 10 mm, or 8.5 mm and 9.5 mm. In an example, the chamber 102 has a diameter of about 9 mm.

### Methods for Using Vapor Delivery Devices

Another aspect of the invention provides a method for vaporizing a vaporizable substance using a vapor deliver device. The vapor delivery device may be as described elsewhere herein. For example, the vapor delivery device can be the device 100 of FIG. 1.

First, a fluid is directed along a fluid flow path of a housing of the vapor delivery device. The fluid flow path comprises a fluid inlet, a sensor, an atomizer, and a fluid outlet. The housing comprises an energy storage unit in a chamber of the housing. The chamber fluidically isolates the energy storage unit from the fluid flow path.

Next, the flow of the fluid is sensed by the sensor. The sensor may be a capacitance (or pressure) sensor and sensing the flow of the fluid comprises sensing a change in capacitance of the sensor, as may be performed with the aid of a controller of the sensor. Next, upon sensing the fluid flow, the energy storage unit is electrically coupled to the atomizer to vaporize the vaporizable substance that is in thermal communication with the atomizer. In an example, the atomizer is in thermal contact with a cotton roll that has been soaked in a vaporizable substance, such as nicotine, and supplying power to the atomizer generates heat that is transferred (e.g., by conductive, convective, and/or radiative energy transfer) to the cotton roll. The transferred heat vaporizes the vaporizable substance. The vaporizable substance is then directed along the fluid flow path to the fluid outlet. In some cases, the vaporizable substance is directed to the body of a subject, such as the mouth and/or lung(s) of the subject.

In some examples, the fluid is directed upon the application of positive pressure to a fluid inlet of the device, the application of negative pressure to a fluid outlet of the device, or both. Negative pressure may be provided with the aid of a vacuum, such as a vacuum (or suction) generated by the mouth of a subject. Positive pressure may be provided with the aid of a pump.

During operation of the device, fluid (e.g., air) flows from the fluid inlet to the fluid outlet. The sensor, upon sensing fluid flow, provides an electrical flow path from the energy storage unit to the atomizer. The atomizer aids in vaporizing the vaporizable substance, as described elsewhere herein.

In some cases, fluid flow is from the fluid inlet and through the sensor. Fluid is then brought in proximity to the atomizer and subsequently directed to the fluid outlet. The fluid does not come in contact with the chamber. As an alternative, fluid may flow from the fluid inlet, around the chamber, through the sensor and through (or in proximity to) the atomizer prior to being directed to the fluid outlet. In such a case, the chamber is configured to minimize, if not eliminate, the fluid from coming in contact with the energy storage unit (e.g., lithium ion battery).

### Example

A vapor delivery device has the configuration of components provided in FIG. 4. The device comprises a holding unit that is a cotton roll that has been contacted with a solution comprising nicotine. The cotton roll is adjacent to an atomizer of the device. The device comprises a sensor that is disposed between the atomizer and a chamber having disposed therein an energy storage unit (e.g., battery). A fluid inlet is situated on a body of the device, between the chamber and the sensor of the device (along a longitudinal axis of the device). A fluid outlet is situated at an end of the device adapted to come in contact with a subject's mouth.

A subject places the end of the device having the fluid outlet in the subject's mouth and provides suction to the fluid outlet. The suction induces a pressure drop from the fluid inlet, which may be at atmospheric pressure (e.g., 1 atm), to the fluid outlet, which may be at a pressure below atmospheric pressure. The pressure drop induces fluid flow (along a fluid flow path) from the fluid inlet, through the sensor and the atomizer, and to the fluid outlet. Upon fluid flow, little to no flowing fluid from the fluid flow path enters the chamber. Upon fluid flow, the sensor provides an electrical flow path from the energy storage unit to the atomizer, which enables the energy storage unit to supply electricity to the atomizer. The supply of electricity to the atomizer generates heat, which is transferred to the cotton roll to vaporize nicotine. Vaporized nicotine is entrained in the flow fluid and directed to the mouth of the subject.

Upon the termination of suction pressure, fluid flow is terminated and the sensor removes the electrical flow path between the energy storage unit and the atomizer to terminate the vaporization of nicotine.

Vapor delivery devices of the disclosure may be combined with, or modified by, other devices, such as devices disclosed in U.S. Pat. No. 7,832,410 to Hon (“ELECTRONIC ATOMIZATION CIGARETTE”), which is entirely incorporated herein by reference.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

1. A vapor delivery device, comprising:
a housing having a fluid flow path comprising a fluid inlet, a fluid sensor, an atomizer, and a fluid outlet downstream of the fluid inlet, wherein said housing is configured to facilitate the flow of a fluid from said fluid inlet to said fluid outlet upon the application of (i) a positive pressure source to said fluid inlet, or (ii) a negative pressure source to said fluid outlet; and
an energy storage unit disposed in a chamber of said housing and electrically coupled to said sensor, wherein said chamber fluidically isolates said energy storage unit from said fluid flow path,
wherein said sensor is configured to electrically couple said energy storage unit to said atomizer upon fluid flow along said fluid flow path, which coupling provides power to said atomizer to vaporize a vaporizable substance in thermal communication with said atomizer, which vaporizable substance is directed along said fluid flow path to said outlet.

2-12. (canceled)

13. The vapor delivery device of claim 1, wherein said housing comprises, in sequence, (i) said chamber, fluid inlet, fluid sensor, atomizer and fluid outlet, (ii) said chamber, fluid inlet, atomizer, fluid sensor and fluid outlet, or (iii) said fluid inlet, fluid sensor, chamber, atomizer and fluid outlet.

14-18. (canceled)

19. The vapor delivery device of claim 1, wherein said sensor comprises an electronic controller and an air-triggered switch, and wherein said air-triggered switch is situated along said fluid flow path.

20-22. (canceled)

23. The vapor delivery device of claim 1, further comprising a divider situated along said fluid flow path, wherein said divider bisects said housing into a first portion and a second portion, and wherein said divider includes one or more channels extending through the divider.

24. The vapor delivery device of claim 23, wherein said divider comprises one or more additional channels orthogonal to said one or more channels, wherein said one or more additional channels are configured to direct fluid flow along said fluid flow path to said atomizer.

25. A method for vaporizing a vaporizable substance, comprising:
(a) directing fluid flow along a fluid flow path of a housing, said fluid flow path comprising a fluid inlet, a sensor, an atomizer, and a fluid outlet, wherein said housing comprises an energy storage unit in a chamber of said housing, wherein said chamber fluidically isolates said energy storage unit from said fluid flow path;
(b) sensing, with the aid of said sensor, said fluid flow of (a);
(c) upon sensing said fluid flow, electrically coupling said energy storage unit to said atomizer to vaporize said vaporizable substance in thermal communication with said atomizer; and
(d) directing said vaporizable substance along said fluid flow path to said fluid outlet.

26. (canceled)

27. The method of claim 25, wherein said housing is a single-piece housing.

28. The method of claim 25, wherein said housing is a two-piece housing or three-piece housing.

29. (canceled)

30. The method of claim 25, wherein, along a longitudinal axis of said housing, said fluid inlet is disposed between said energy storage unit and said fluid outlet.

31. The method of claim 30, wherein, along a longitudinal axis of said housing, said sensor is disposed between said chamber and said atomizer.

32-46. (canceled)

47. A vapor delivery device, comprising:
a housing having a fluid inlet in fluid communication with a fluid outlet along a fluid flow path; and
an energy storage unit, an atomizer, and a sensor within the housing, wherein said energy storage unit disposed in a chamber that fluidically isolates said energy storage unit from said fluid flow path.

48. The vapor delivery device of claim 47, wherein said energy storage unit is hermetically sealed in said chamber.

49-53. (canceled)

54. The vapor delivery device of claim 47, wherein said housing comprises a first housing module removably attached to a second housing module, said first housing module comprising said chamber.

55. The vapor delivery device of claim 54, wherein said first housing module comprises said sensor.

56. The vapor delivery device of claim 54, wherein said second housing module comprises said sensor.

57-70. (canceled)

71. An vapor delivery device, comprising:
a housing having a fluid flow path comprising a fluid inlet, a fluid sensor, an atomizer, and a fluid outlet downstream of the fluid inlet, wherein said housing is configured to facilitate the flow of a fluid from said fluid inlet to said fluid outlet upon the application of (i) a positive pressure source to said fluid inlet, or (ii) a negative pressure source to said fluid outlet; and
an energy storage unit disposed in a chamber of said housing and electrically coupled to said sensor, wherein said fluid flow path is directed around said chamber along one or more channels formed between said chamber and an interior portion of said housing,
wherein said sensor is configured to electrically couple said energy storage unit to said atomizer upon fluid flow along said fluid flow path, which coupling provides power to said atomizer to vaporize a vaporizable substance in thermal communication with said atomizer, which vaporizable substance is directed along said fluid flow path to said outlet.

72-81. (canceled)

82. The vapor delivery device of claim 71, wherein said housing comprises an electronic visual indicator electrically coupled to said sensor, wherein said sensor is configured electrically couple said energy storage unit to said electronic visual indicator upon fluid flow along said fluid flow path.

83-85. (canceled)

86. The vapor delivery device of claim 71, wherein said energy storage unit is a battery.

87. The vapor delivery device of claim 71, wherein said vaporizable substance is disposed in a liquid holding unit in thermal communication with said atomizer.

88. The vapor delivery device of claim 71, wherein said atomizer is in thermal contact with said vaporizable substance.

89-96. (canceled)
